(19) United States
(12) Patent Application Publication
(10) Pub. No.: US 2013/0000492 A1
(43) Pub. Date: Jan. 3, 2013

(54) HOT-AIR DUAL-PURPOSE STOVE

(75) Inventor: CHIU-KUNG LIN, NEW TAIPEI CITY (TW)

(73) Assignees: SING YOW INDUSTRIAL CO., LTD., NEW TAIPEI CITY (TW); LEN CHEN ENTERPRISES CO., LTD., TAIPEI CITY (TW)

(21) Appl. No.: 13/173,005

(22) Filed: Jun. 30, 2011

(51) Int. Cl. A47J 36/00; A47J 37/00

(52) U.S. Cl. 99/348

(57) ABSTRACT

The present invention discloses a hot-air dual-purpose stove comprising a pot body, a pot cover, a hot air generator, a motor and a spatula. The pot cover is pivotally coupled to a side of the pot body, and the hot air generator is installed at the center of the pot cover, and the motor is installed at the bottom of the pot body, and the pot cover is covered onto the pot body to form a confined heating space. In addition, an installing hole is formed at the bottom of the pot body for passing out a drive shaft of the motor and coupling with the spatula inside the pot body to drive and rotate the spatula. The invention is characterized in that the spatula has a quick release structure for installing or removing the quick release structure quickly to improve the convenience of use significantly.

### BACKGROUND OF THE INVENTION

1. Field of the Invention

The present invention generally relates to cooking utensils, in particular to a hot-air dual-purpose stove structure used for cooking food, and the structure includes a spatula installed inside a pot body, and the spatula can be installed or removed easily.

2. Description of the Related Art

The traditional cooking of food uses nothing more than pan frying, boiling, deep frying, steaming, stewing, poaching, baking, and other cooking methods. With different seasonings, various different dishes can be made. As to the baking method, heat is applied directly to the surface of food. For example, the heat generated by at least one heater (such as a heating lamp tube) installed in a confined space of an oven is used for baking food. Since most people like crispy baked food, it is necessary to pay much attention to whether or not the food is well done without burning the surface of the food when the oven is used. Therefore, a new hot-wind oven is introduced, wherein hot air is used as a heat source, and the hot air can penetrate through the interior of the food, not only cooking the food well, but also taking the effect of a crispy surface of the food in consideration.

In recent years, the hot-wind oven is developed for pan frying. Unlike the conventional baking method, a motor is installed at the bottom of the hot-wind oven and coupled to a spatula installed in the hot-wind oven. During the heating process, the hot-wind oven is in a closed condition, and the spatula is driven by the motor to rotate, so as to turn over the food constantly.

Since the spatula is installed or removed according to the using requirements, most of the present spatulas come with a quick release structure to be latched into an installing hole of the hot-wind oven to provide a relatively convenient application, yet the structure of the quick release structure is usually too complicated, and cannot be removed for repair after the structure is installed, thus incurring a high maintenance cost.

In view of the shortcomings of the conventional structure, the invention of the present invention discloses a hot-air dual-purpose stove having a quick release structure installed on a spatula, and the quick release structure comprises a turntable and at least one pair of hook handles, and the turntable has a circular groove for containing an end of each of the pair of hook handles. When the turntable is rotated, a hook portion at another end of each of the pair of hook handles is propped outward or retracted inward. In addition, the turntable of the present invention comes with a novel design, such that it can be secured without turning for several rounds, but simply requiring a rotation to an appropriate angle to achieve the effect of releasing or latching the turntable, so as to provide a more convenient operation.

In view of the aforementioned shortcomings of the prior art, the inventor of the present invention discloses a micro sensing device to overcome the shortcomings of the prior art.

### SUMMARY OF THE INVENTION

Therefore, it is a primary objective of the present invention to provide a hot-air dual-purpose stove capable of cooking food by baking and frying methods, so as to offer more purposes of use and improve the practical application of the stove.

Another objective of the present invention is to provide a hot-air dual-purpose stove adopting a spatula structure, and a novel quick release structure to provide a convenient installation or removal.

To achieve the foregoing objective, the present invention provides a hot-air dual-purpose stove, comprising: a pot body, having an installing hole formed at the center of the pot body; a pot cover, pivotally coupled to a side of the pot body, and covered onto the pot body, and having an installing portion disposed at the center of the pot cover; a hot air generator, installed at the installing portion, for sending hot air towards the interior of the pot body; a motor, installed at the bottom of the pot body, and having a drive shaft passed through the installing hole and disposed inside the pot body; a spatula, installed inside the pot body and coupled to the drive shaft, and having a main body and a swinging arm, and the swinging arm being an arc structure installed in a tangential direction of the main body; and a quick release structure, installed on the main body, and including a turntable and at least one pair of hook handles, and the turntable being installed and rotated at the top of the main body, and an end of the pair of hook handles being passed out from the top of the main body and coupled to the turntable, and another end of the pair of hook handles having a hook portion, such that the turntable is turned to drive the pair of hook handles to prop outward or retract inward to latch or separate the hook portions with respect to the pot body. Wherein, the main body further has a containing hole formed inside the main body for inserting the drive shaft.

In a preferred embodiment, the hot-air dual-purpose stove further comprises a support frame bent to form a containing portion for containing the pot body, and a first connecting portion disposed on a side of the support frame and coupled to a side of the pot cover. The pot cover comes with a lift-open design. After the pot cover is opened, there will be no issue of where to put the pot cover, so as to improve the convenience of use tremendously. Alternatively, a second connecting portion can be formed at an external sidewall of the pot body and coupled to a side of the pot cover, so that the lift-open design of the pot cover overcomes the issue of where to put the pot cover after the pot is opened, so as to improve the convenience of use.

Wherein, the spatula has a cantilever with a cross-section substantially in a triangular shape, and a volume tapered outwardly towards the main body, and a bump is formed at an end of the cantilever to improve the effect of stirring and turning over the food during cooking in order to heat the food more easily and uniformly.

Wherein, the turntable includes a circular groove formed thereon, and an end of each hook handle has a spherical body, and the spherical bodies are contained in the circular groove, and a pair of nearest points and a pair of farthest points are defined within the distance from the circular groove and the center of the turntable, such that after the turntable is rotated, the spherical bodies in the circular groove slide to drive the hook portions at another end of the hook handles to prop outward or retract inward. In addition, the main body has a screw hole and two groove holes formed at the top of the main body, and a through hole formed at the center of the turntable, and a fixing screw is passed through the through hole and secured into the screw hole, so that the turntable can be rotated with respect to the main body, and the pair of hook handles are disposed in the groove holes respectively. In addition, an arc-shaped limit hole is formed at a position proximate to the screw hole, and a protruding pillar disposed proximate to the screw hole, and a portion of the protruding pillar being movably contained in the limit hole. When the spatula is used, the turntable can be loosened or secured by turned the turntable to both end points of the limit hole, and this design not only provides a convenient installation, but also provides a convenient use.

The detailed structure, operating principle and effects of the present invention will now be described in more details hereinafter with reference to the accompanying drawings that show various embodiments of the invention as follows.

### BRIEF DESCRIPTION OF THE DRAWINGS

FIG. 1 is a schematic perspective view of a structure of a preferred embodiment of the present invention;

FIG. 2 is a schematic perspective view of a preferred embodiment of the present invention after a spatula is installed;

FIG. 3 is a schematic view of a structure with a quick release structure and a spatula in accordance with a preferred embodiment of the present invention;

FIG. 4 is a first schematic view of operating a quick release structure in accordance with a preferred embodiment of the present invention; and

FIG. 5 is a second schematic view of operating the quick release structure in accordance with a preferred embodiment of the present invention.

### DETAILED DESCRIPTION OF THE PREFERRED EMBODIMENTS

The technical content of the present invention will become apparent by the detailed description of the following embodiments and the illustration of related drawings as follows.

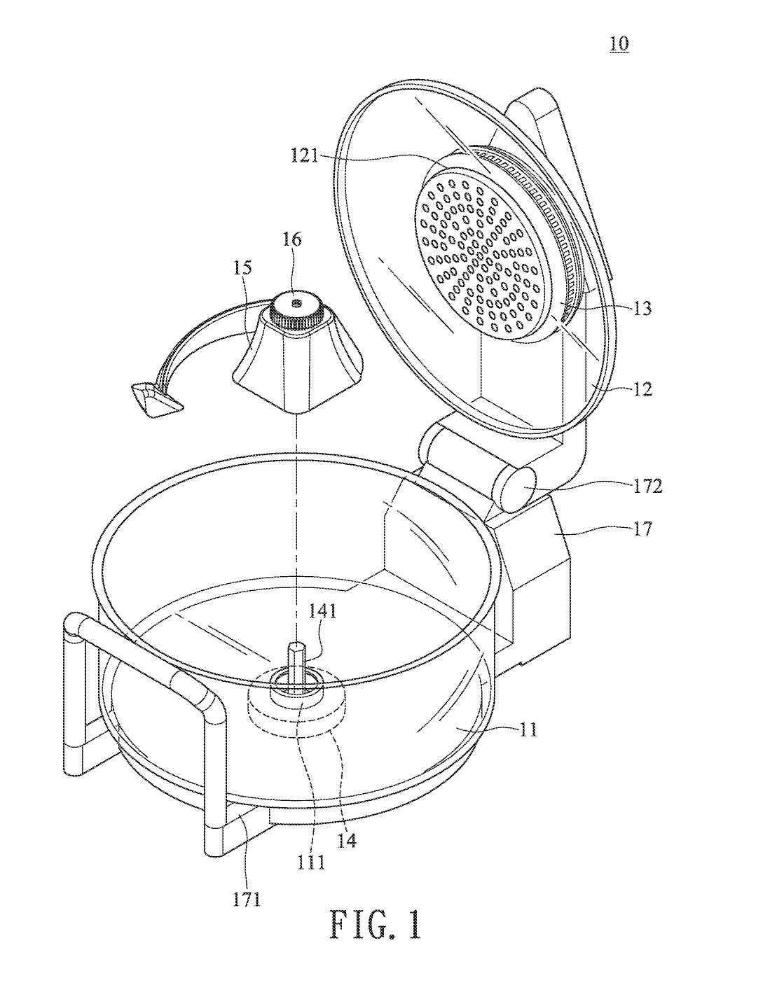

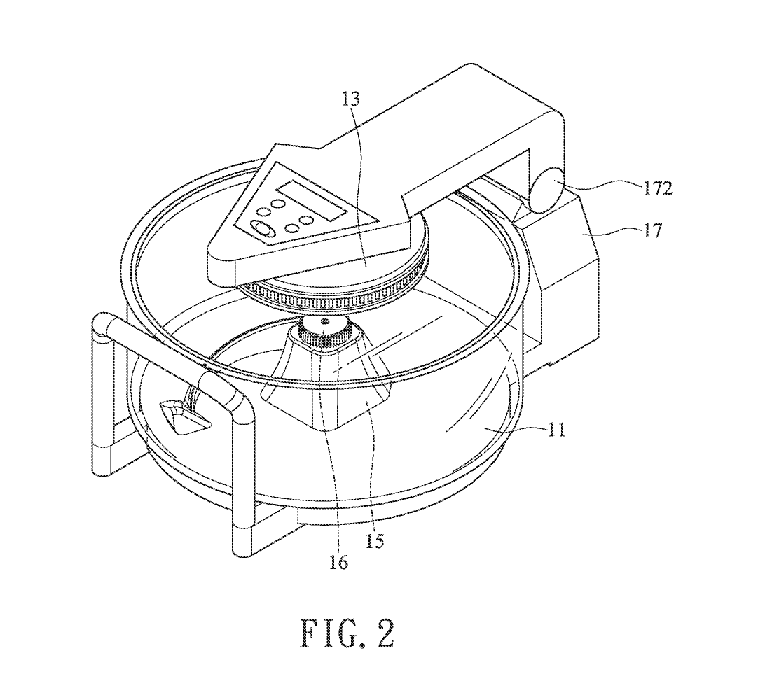

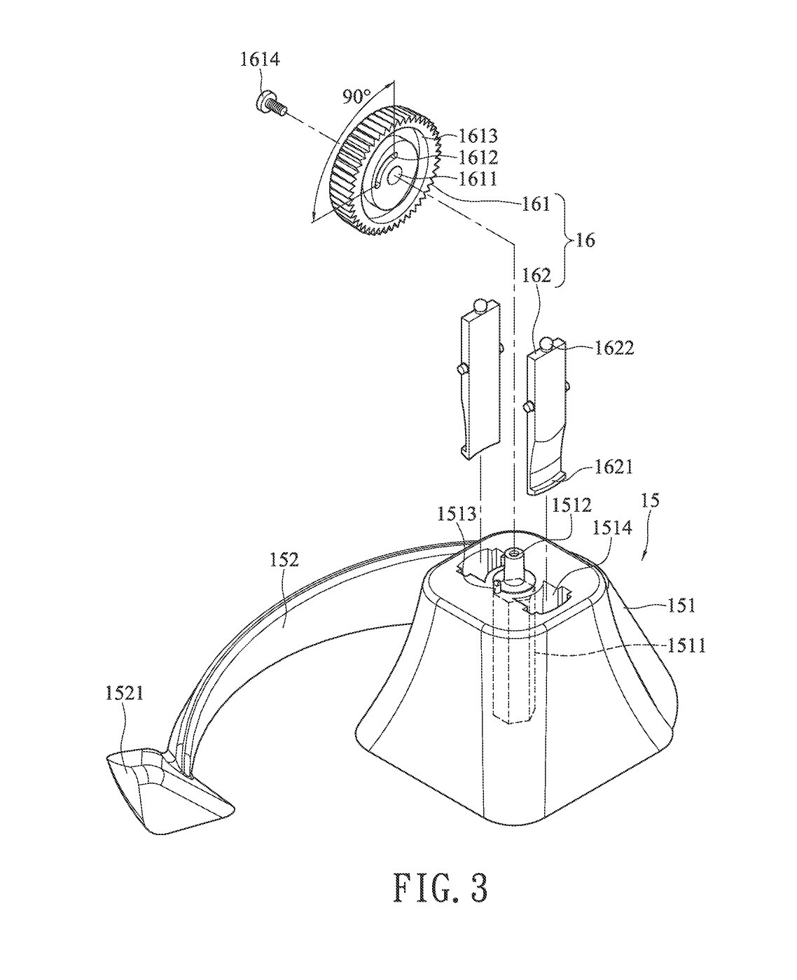

With reference to FIGS. 1, 2 and 3 for schematic views of a structure, the structure installed with a spatula, and a structure installed with a quick release structure and the spatula in accordance with a preferred embodiment of the present invention, a hot-air dual-purpose stove 10 of the present invention comprises a pot body 11, a pot cover 12, a hot air generator 13, a motor 14, a spatula 15, a quick release structure 16 and a support frame 17.

Wherein, the pot body 11 is made of a transparent glass material to facilitate users to observe the cooking food. However, the material of the pot body 11 is not limited to glass only, but any heat resisting and durable resisting material can be used as well. In addition, an installing hole 111 is formed at the center of the pot body 11.

The pot cover 12 is provided for covering and sealing the pot body 11, and an installing portion 121 is formed at the center of the pot cover 12.

The hot air generator 13 is embedded and installed in the installing portion, and provided for sending hot air into the interior of the pot body 11 after the hot air generator is connected to electric power.

The motor 14 is installed at the bottom of the pot body 11, and the motor 14 includes a drive shaft 141 passed out from the installing hole 111 and disposed inside the pot body 11, wherein the drive shaft 141 is a hexagonal pillar shaped structure.

The spatula 15 is installed inside the pot body 11, and the spatula includes a main body 151 and a swinging arm 152, wherein the main body 151 is a structure with a protruding middle and a seat shaped structure around the protruding middle, and a containing hole 1511 is formed inside the main body, and the containing hole 1511 has a shape corresponding to the shape of the drive shaft 141 for inserting the drive shaft 141 to constitute a connecting state. A screw hole 1512 is formed at the center of the top of the main body 151, and a protruding pillar 1513 is disposed proximate to a side of the screw hole 1512, and a groove hole 1514 is formed separately on both sides of the screw hole 1512 and the protruding pillar 1513. In addition, the swinging arm 152 is an arc structure installed in a tangential direction of the main body 151, and around the main body 151 (viewing from the top), and the cantilever 152 has a cross-section substantially in a triangular shape, and a volume tapered outwardly from the main body 151, and a bump 1521 is formed and protruded from an end of the cantilever 152.

The quick release structure 16 is installed at the top of the main body 151, and the quick release structure 16 includes a turntable 161 and a pair of hook handles 162, wherein the turntable 161 is installed at the top of the main body 151 and rotatable, and the pair of hook handles 162 are passed into the groove holes 1514 respectively, and an end of each of the pair of hook handles 162 is passed out from the top of the main body 151 and coupled to the turntable 161, and another end of each of the pair of hook handles 162 has a hook portion 1621, such that the turntable 161 can be rotated to drive the pair of hook handles 162 to produce an effect such as propping outward or retracting inward similar to a see-saw movement. Wherein, the turntable 161 includes a through hole 1611, a limit hole 1612 and a circular groove 1613 formed on the turntable 161, and an end of each of the hook handles 162 has a spherical body 1622, and the spherical bodies 1622 are contained in the circular groove 1613, and a pair of nearest points 16131 and a pair of farthest points 16132 defined between the distance from the circular groove 1613 to the center of the turntable 161. When the turntable 161 is rotated, the spherical bodies 1622 will slide along the circular groove 1613 to drive the hook portions 1621 at another end of each of the hook handles 162 to prop outward or retracted inward. When the spatula 15 and the quick release structure 1 of the present invention are assembled, a fixing screw 1614 is passed through the through hole 1611 of the turntable 161 and secured into the screw hole 1512, such that the turntable 161 can be rotated with respect to the main body 151. In addition, the limit hole 1612 is in a circular arc shape with a corresponding angle of approximately 90, and the main body 151 has a protruding pillar 1513 installed at a position proximate to the screw hole 1512, and a portion of the protruding pillar 1513 is movably contained in the limit hole 1612.

The support frame 17 is bent to form a containing portion 171 for containing the pot body 11, and a first connecting portion 172 is disposed on a side of the support frame 17 and coupled to a side of the pot cover 12, such that the pot cover 12 has a lift-open design, and there will be no issue of where to put the pot cover 12 after the pot is opened, so as to improve the convenience of use significantly. Alternately, a second connecting portion (not shown in the figure) is disposed on an external sidewall of the pot body 11 and coupled a side of he pot cover 12 as well as to provide the lift-open design of the pot cover 12.

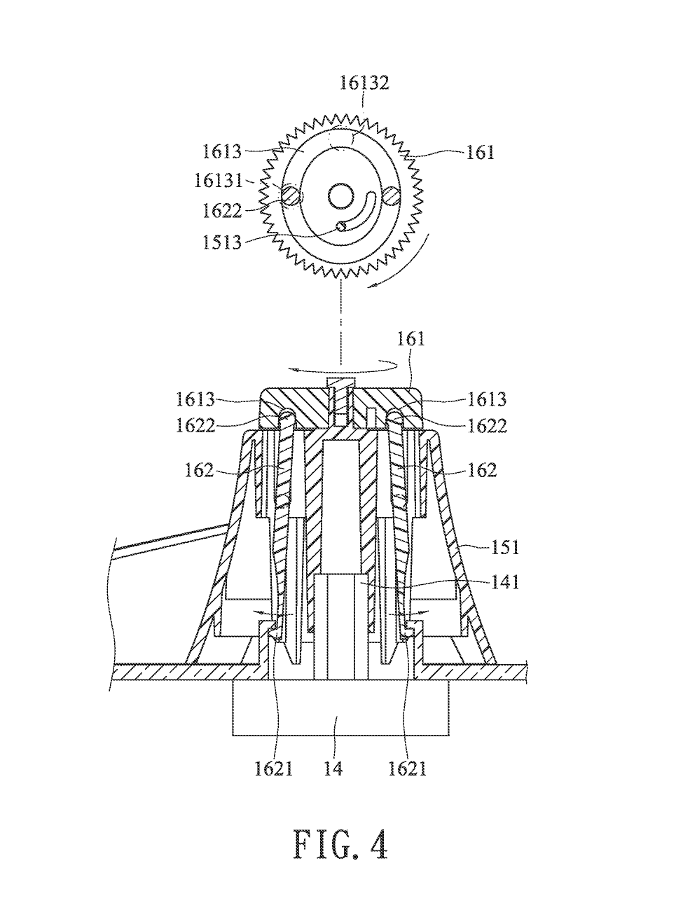

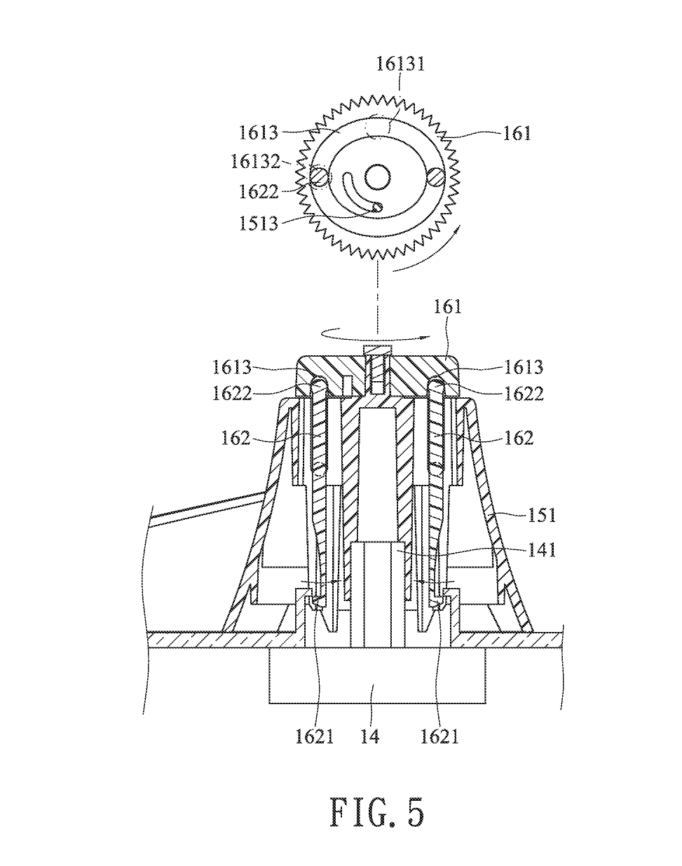

With reference to FIGS. 4 and 5 for schematic views of different situations of operating a quick release structure in accordance with a preferred embodiment of the present invention, when the spatula 15 is installed to the pot body 11, the main body 151 is mounted onto the installing hole 111 of the pot body, and the drive shaft 141 is installed and coupled into the containing hole 1511. The turntable 161 is rotated, such that the spherical bodies 1622 of the hook handles 162 slide along the circular groove 1613. When the spherical body 1622 slides to the nearest points 16131, the hook handles 162 are swung outward, such as the hook portions 1621 are propped outward to achieve the effect of latching the installing hole 111 of the pot body 11. On the other hand, when it is necessary to remove the spatula 15, the turntable 161 is rotated in a reverse direction, such that the spherical bodies 1622 slide to the farthest points 16132, and the hook handles 162 are swung inward, such that the hook portions 1621 are retracted inward to separate the spatula from the pot body 11 easily to provide a simple, easy and convenient operation.

In summation, the novel design of the quick release structure 16 of the present invention facilitates the combination and separation of the spatula 15 and the pot body 11 and provides a very convenient way for users to install or remove the spatula 15. In addition, if it is necessary to maintain or repair the quick release structure 16, individual parts can be replaced to avoid an unnecessary waste of material.

While the invention has been described by means of specific embodiments, numerous modifications and variations such as the shape, material, or dimensions of the pot body 11 and the pot cover 12, the shape and power of the motor 14, or the material, shape and dimensions of the spatula 15 could be made thereto by those skilled in the art without departing from the scope and spirit of the invention set forth in the claims. In summation of the description above, the present invention improves over the prior art and complies with the patent application requirements, and thus is duly file for patent application.

What is claimed is:

1. A hot-air dual-purpose stove, comprising:
a pot body, having an installing hole formed at the center of the pot body;
a pot cover, pivotally coupled to a side of the pot body, and covered onto the pot body, and having an installing portion disposed at the center of the pot cover;
a hot air generator, installed at the installing portion, for sending hot air towards the interior of the pot body;
a motor, installed at the bottom of the pot body, and having a drive shaft passed through the installing hole and disposed inside the pot body;
a spatula, installed inside the pot body and coupled to the drive shaft, and having a main body and a swinging arm, and the swinging arm being an arc structure installed in a tangential direction of the main body; and
a quick release structure, installed on the main body, and including a turntable and at least one pair of hook handles, and the turntable being installed and rotated at the top of the main body, and an end of the pair of hook handles being passed out from the top of the main body and coupled to the turntable, and another end of the pair of hook handles having a hook portion, such that the turntable is turned to drive the pair of hook handles to prop outward or retract inward to latch or separate the hook portions with respect to the pot body.

2. The hot-air dual-purpose stove of claim 1, further comprising a support frame bent to form a containing portion for containing the pot body, and a first connecting portion disposed on a side of the support frame and coupled to a side of the pot cover.

3. The hot-air dual-purpose stove of claim 1, wherein the pot body includes a second connecting portion disposed on an external sidewall of the pot body and coupled to a side of the pot cover.

4. The hot-air dual-purpose stove of claim 1, wherein the spatula has a cantilever with a cross-section substantially in a triangular shape and a volume tapered towards the outside of the main body, and a bump protruded from an end of the cantilever.

5. The hot-air dual-purpose stove of claim 1, wherein the main body further includes a containing hole defined inside the main body for inserting the drive shaft.

6. The hot-air dual-purpose stove of claim 1, wherein the turntable includes a circular groove formed thereon, and an end of each hook handle has a spherical body, and the spherical bodies are contained in the circular groove, and a pair of nearest points and a pair of farthest points are defined within the distance from the circular groove and the center of the turntable, such that after the turntable is rotated, the spherical bodies in the circular groove slide to drive the hook portions at another end of the hook handles to prop outward or retract inward.

7. The hot-air dual-purpose stove of claim 6, wherein the main body has a screw hole and two groove holes formed at the top of the main body, and a through hole formed at the center of the turntable, and a fixing screw is passed through the through hole and secured into the screw hole, so that the turntable can be rotated with respect to the main body, and the pair of hook handles are disposed in the groove holes respectively.

8. The hot-air dual-purpose stove of claim 7, further comprising an arc-shaped limit hole formed at a position proximate to the screw hole, and a protruding pillar disposed proximate to the screw hole, and a portion of the protruding pillar being movably contained in the limit hole.
